(19) United States
(12) Patent Application Publication
(10) Pub. No.: US 2013/0285573 A1
(43) Pub. Date: Oct. 31, 2013

(54) CONTROLLED AREA LIGHTING FOR USE IN MINING ENVIRONMENTS

(71) Applicant: JOY MM DELAWARE, INC., Wilmington, DE (US)

(72) Inventor: Alastair John Paterson, Wollongong (AU)

(21) Appl. No.: 13/871,652

(22) Filed: Apr. 26, 2013

Related U.S. Application Data
(60) Provisional application No. 61/687,522, filed on Apr. 26, 2012.

(51) Int. Cl. H05B 33/08

(52) U.S. Cl. CPC H05B 33/0842
USPC 315/297

(57) ABSTRACT

Systems and methods for controlling lighting in a mining environment. One system includes at least one light emitting diode and a controller. The controller is configured to communicate with the at least one light emitting diode and change the light emitting diode from a first operating mode to a second operating mode. In the first operating mode, the at least one light emitting diode provides area lighting, and, in the second operating mode, the at least one light emitting diode conveys information to personnel located in the mining environment. The controller changes the light emitting diode from the first operating mode to the second operating mode based on status information received from at least one device included in the mining environment.

### RELATED APPLICATIONS

The present application claims priority to U.S. Provisional Application No. 61/687,522, filed Apr. 26, 2012, the entire contents of which are hereby incorporated by reference.

### FIELD OF THE INVENTION

Embodiments of the invention relate to methods and systems for controlling mining equipment, such as lighting used in a mining environment.

### SUMMARY OF THE INVENTION

Mining equipment typically includes a large number of structures that move relative to each other, often in a sequence. For example, a miner, such as a longwall shearer, can be positioned under one or more roof supports. The shearer cuts material, such as coal, and loads the cut material onto a conveyor upon which the shearer is mounted. The shearer hauls itself along the conveyor as it cuts the material, and the roof supports advance after the shearer passes.

Embodiments of the invention provide lighting for mining environments. In particular, embodiments of the present invention provide area lighting for a mining environment and control various features of the lighting to also convey information to personnel located in the environment. For example, in some embodiments, light emitting diodes (“LEDs”) are positioned on the roof supports and are controlled by a controller. For example, the controller can vary the LEDs' color, brightness, and/or status (e.g., on, off, flashing, etc.) to convey information to personnel working in the mine, such as the location of dangerous conditions. Accordingly, the lighting serves two purposes: (1) area lighting and (2) information transmission.

In particular, one embodiment of the invention provides a system for controlling lighting in a mining environment. The system includes at least one light emitting diode and a controller. The controller is configured to communicate with the at least one light emitting diode and change the light emitting diode from a first operating mode to a second operating mode. In the first operating mode, the at least one light emitting diode provides area lighting, and, in the second operating mode, the at least one light emitting diode conveys information to personnel located in the mining environment. The controller changes the light emitting diode from the first operating mode to the second operating mode based on status information received from at least one device included in the mining environment.

Another embodiment of the invention provides a method for controlling lighting in a mining environment. The method includes operating, by at least one controller, a plurality of light emitting diodes located in the mining environment on at least one of a roof support and a stage loader. The method also includes receiving, at the at least one controller, information associated with the mining environment, and operating, by the at least one controller, at least one of the plurality of light emitting diodes to convey information to personnel located in the mining environment based on the received information. Operating the at least one of the plurality of light emitting diodes to convey information includes changing at least one of the color, brightness, and flashing sequence of the at least one of the plurality of light emitting diodes.

Other aspects of the invention will become apparent by consideration of the detailed description and accompanying drawings.

### BRIEF DESCRIPTION OF THE DRAWINGS

FIG. 1 is a side view of a mining system including a mining machine and a roof support system.

FIG. 2 schematically illustrates a lighting controller for the mining system of FIG. 1.

FIG. 3 is a flow chart illustrating a lighting control method performed by the controller of FIG. 2.

FIG. 4 illustrates a stage loader.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

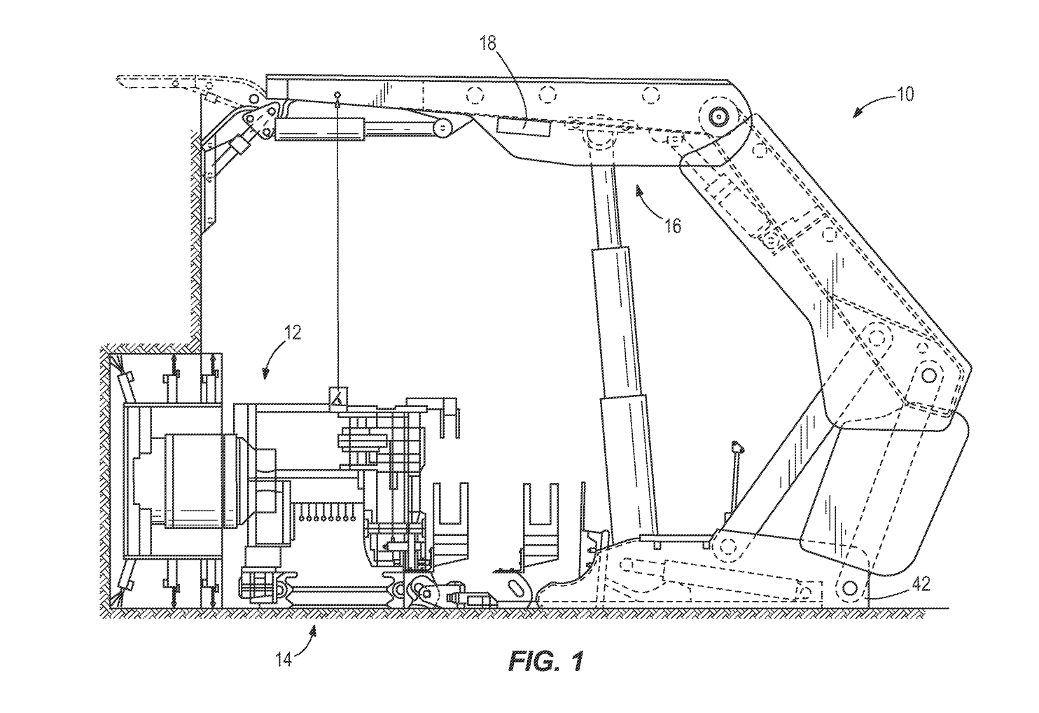

FIG. 1 illustrates a mining system 10 including a mining machine, such as a longwall shearer 12 carried on a face conveyor 14, and a roof support system including cantilevered roof supports 16 (e.g., forming a roof support canopy). The shearer 12 cuts material (e.g., coal) and loads the cut material onto the conveyor 14 upon which the shearer 12 is mounted. The shearer 12 moves along the conveyor 14 as the shearer 12 cuts the material. The individual roof supports 16 advance after the shearer 12 passes. It should be understood that FIG. 1 illustrates only one example of a mining system 10 and that other systems are possible including other configurations of roof support systems and other types of mining machines.

As described above, lighting, such as light emitting diodes (“LEDs”), can be installed in the mine around the mining system 10. For example, as illustrated in FIG. 1, the lighting can include one or more lights 18 positioned one or more of the roof supports 16 (e.g., an under-side of the roof supports 16). In some embodiments, the lights 18 can be multi-colored (e.g., red, blue, and green) or white. For example, in some embodiments, the lights 18 include red-green-blue LEDs. As described below in more detail, the color of a light 18 can be changed to convey information to personnel located in the mine. For example, a light 18 can be changed to red to signal danger due to potential equipment movement and can be changed to green to signal safe conditions. In some embodiments, the color sequence is based on the equipment movement during the cutting sequence. For example, as the roof supports 16 and the shearer 12 are advanced, lights 18 located toward an end of the roof supports 16 may be changed to red when the roof supports 16 are advanced to indicate movement of the roof support, which can be a hazard to personnel and other equipment located in the mine. Other colors can also be used to convey information to personnel. For example, a light 18 can be changed to blue when it is unclear whether an area is safe for personnel. A light 18 can also be flashed or strobed to indicate an alarm or warning condition (e.g., a collision is likely). A set of lights 18 can also be flashed in a particular sequence to direct personnel to safe locations or away from dangerous locations. For example, the lights 18 can strobe toward an exit of a mine or away from a dangerous condition. In general, the features of each light 18 or a set of lights 18, such as color, brightness, status (e.g., on, off, flashing, etc.), pattern, etc., can be controlled and varied to convey information to personnel located in the mine. Also, in some embodiments each of the lights 18 has two operating modes or settings. In a first operating mode, the light 18 is controlled to provide area lighting (e.g., substantially steady, white light). In a second operating mode, the light 18 is controlled to convey information (e.g., changing the light's color, status, brightness, etc.). In other embodiments, separate lights can be used to provide area lighting and to convey information.

The lights 18 are controlled by a controller 20. It should be understood that the controller 20 can be mounted at various locations within and around the mining system 10, such as included in the roof support system or included in the mining machine. In some embodiments, controller 20 is configured to control aspects of the mining system 10 other than the lights 18, such as the advancement of the roof supports 16. For example, the controller 20 can be integrated into a roof support controller or other mining systems.

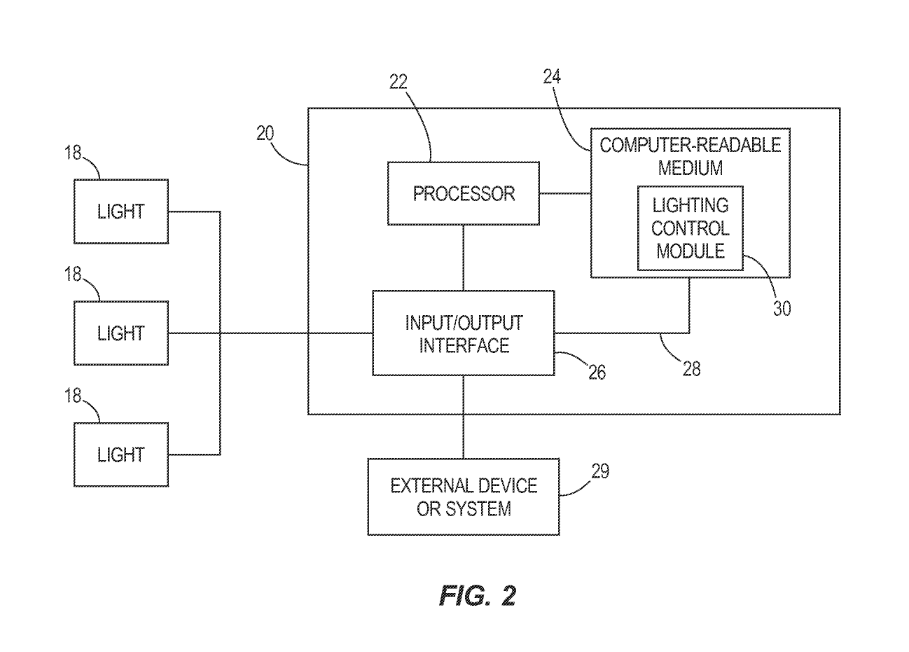

FIG. 2 schematically illustrates the controller 20 according to one embodiment of the invention. It should be understood that FIG. 2 illustrates only one example of components of the controller 20 and that other configurations are possible. As shown in FIG. 2, the controller 20 includes a processor 22, computer-readable medium, 24, and an input/output interface 26. The processor 22, computer-readable medium 24, and input/output interface 26 are connected by one or more connections 28, such as a system bus. It should be understood that although only one processor 22, computer-readable medium module 24, and input/output interface 26 are illustrated in FIG. 2, the controller 20 can include multiple processors 22, computer-readable medium modules 24, and input/output interfaces 26. Also, as noted above, it should be understood that the controller 20 can be combined with and/or distributed among other controllers and control systems.

The processor 22 retrieves and executes instructions stored in the computer-readable medium 24. The processor 22 can also store data to the computer-readable medium 24. The computer-readable medium 24 can include non-transitory computer readable medium and can include volatile memory, non-volatile memory, or a combination thereof. As illustrated in FIG. 2, the input/output interface 26 can exchange information with one or more external devices or systems 29. The external devices or systems 29 can include the mining machine, the roof support system, and other equipment included in the mine, such as conveyor systems, user-interfaces or remote controls, ventilation systems, etc. The external devices or systems 29 can also include a remote control system that transmits status information (e.g., commands) to the controller 20. As described in more detail below, the controller 20 can receive status information from the external devices or systems 29 and can control one or more of the lights 18 based on the status information. As illustrated in FIG. 2, the interface 26 is also coupled to the lights 18. The interface 26 can be coupled to the lights 18 and the external devices or systems 29 using a wired connection, a wireless connection, or combinations thereof. For example, in some embodiments, the interface 26 is coupled to the lights 18 through a serial interface.

The instructions stored in the computer-readable medium 24 can include various components or modules configured to perform particular functionality when executed by the processor 22. For example, the computer-readable medium 24 can include a lighting control module 30. The lighting control module 30 can be executed by the processor 22 to control one or more of the lights 18 installed on the roof supports 16. As described above, various aspects of the lights 18, such as color, brightness, and/or status, can be varied by the controller 20 to convey information to personnel located in the mine.

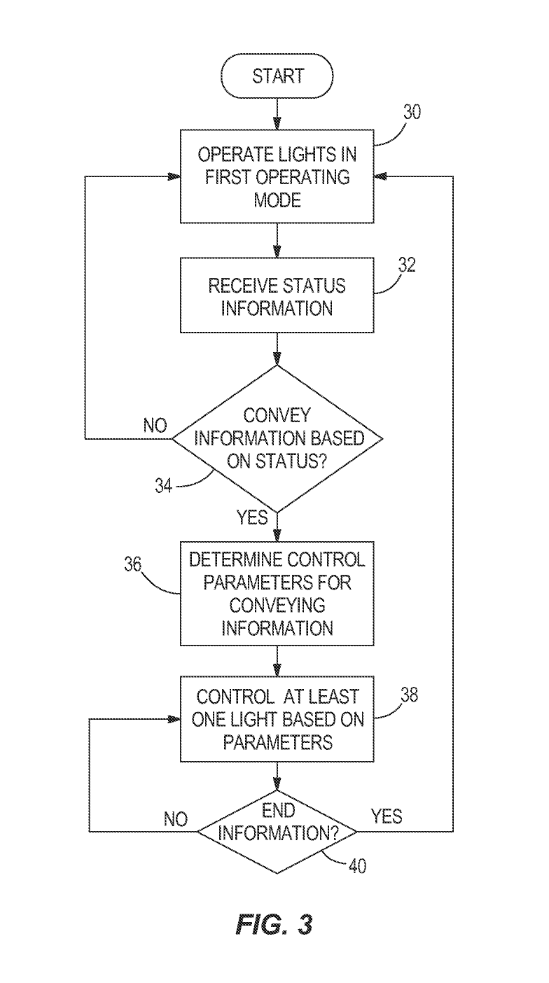

For example, FIG. 3 illustrates a method of controlling the lights 18 performed by the controller 20 executing the module 30. As noted above, the controller 20 can operate each of the lights 18 in a first operating mode where the lights 18 provide area lighting (e.g., substantially steady, white light) (at 30). The controller 20, however, also receives status information from external devices or systems 29 (at 32). For example, the status information can include the position, operational status, and/or movement of the roof supports 16 and the position, operational status (e.g., active cutting), and/or movement of the shearer 12. The status information can also include errors or warnings generated by components of the mining system 10 or other machinery or personnel associated with the mining environment. The controller 20 uses the status information to determine whether information needs to be conveyed to personnel located in the mine (at 34). For example, the controller 20 can be configured to determine whether the received status information indicates that a condition is occurring or could occur within the mine that personnel located in the mine should be alerted of. The condition can include active operation of the shearer 12, detection of poisonous gases, detection of unstable mine structures, maintenance needs (e.g., shearer 12 repair, system repositioning, power failures, bit replacement, etc.), errors, etc.

If the controller 20 determines that information should be conveyed to personnel based on the received status information (i.e., at least one of the lights 18 should be operated in a second operating mode) (at 34), the controller 20 determines how the information should be conveyed. In particular, the controller 34 can determine parameters for controlling at least one of the lights 18 based on the received status information (at 36). In some embodiments, the controller 34 can access various tables, rules, or relationships that map particular status information to particular control parameters for the lights 18. For example, if the status information indicates a dangerous condition that requires complete evacuation of the mine, the rules can define a first set of parameters for controlling the lights 18 to convey information about the dangerous condition (e.g., changing the color of all of the lights 18 and flashing all of the lights). Similarly, if the status information indicates a dangerous condition that requires personnel remain clear of the shearer 12, the rules can define a second set of parameters for controlling the lights 18 to convey information about the condition (e.g., changing the color of all of the lights 18). Furthermore, if the status information indicates that repair or maintenance is required for at least a portion of the mining system 10, the rules can define a third set of parameters (e.g., changing the color of at least one of the lights 18, such as lights 18 at a predefined position or lights positioned in a predetermined pattern). Therefore, the rules define what lights 18 to operate (e.g., lights 18 at particular positions or locations) and how to operate the lights 18 (e.g., what colors, flashing sequences or animations, brightness, etc.) based on the received status information.

The rules can be stored in the computer-readable medium 24 (e.g., as part of the module 30) or in separate computer-readable medium (included in or external to the controller 20). It should also be understood that in some embodiments, rather than receiving status information and determining whether and how to control the lights 18, this logic can be distributed among separate controllers that transmit commands to the controller 20 that define the parameters for controlling the lights 18.

After determining the parameters for controlling the lights 18, the controller 20 controls at least one of the lights 18 based on the determined parameters (at 38) until the controller 20 determines that the information should no longer be conveyed (at 40). In some embodiments the controller 20 is configured to control the lights 18 to convey information for a predetermined period of time. The predetermined period of time can be based on the particular information being conveyed (e.g., based on the parameters defined by the rules described above). In other embodiments, the controller 20 waits for an “end” or “stop” command from personnel or another controller or system. In still other embodiments, the controller 20 continues controlling the lights 18 to convey particular information until status information received by the controller 20 no longer indicates that the information should be conveyed. In some embodiments, when the controller 20 stops controlling the lights 18 to convey information, the controller 20 returns to operating the lights 18 in the first operating mode where the lights 18 provide area lighting. In some embodiments, the controller 20 can also maintain a log of when and how the lights 18 were controlled in the second operating mode. The log can be used to analyze operation of the mien and/or the mining system 10 (e.g., address safety concerns or investigations).

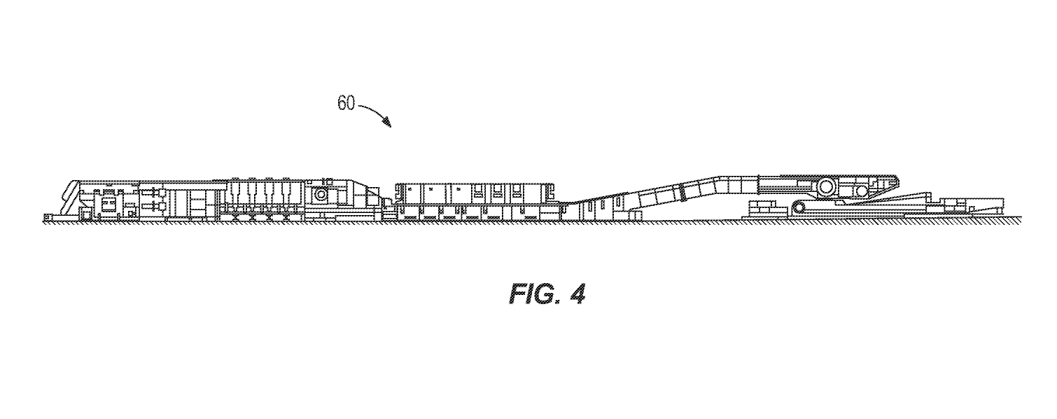

As noted above, the lights 18 can be positioned in various locations within the mine and are not limited to the roof supports 16. For example, in some embodiments, the lights 18 can be installed on a stage loader in addition to or as an alternative to the lights 18 installed on the roof supports 16. FIG. 4 schematically illustrates a stage loader 60 according to one embodiment of the invention. The stage loader 60 includes a steel conveyor installed in an underground tunnel (or roadway). As illustrated in FIG. 4, the cutting face (e.g., a coal face) would be on the left-hand side of the stage loader 60 at approximately ninety degrees to the roadway.

After material is mined by the shearer 12, the stage loader 60 is pushed (to the right in FIG. 4) by the roof supports 16. Lights on the stage loader 60 can be provided around the cutting face and/or along at least a portion of the length of the stage loader 40 (e.g., approximately 40 meters). During operation, the stage loader 60 is pushed by the roof supports 16 and movement of both pieces of equipment creates highly dangerous conditions. Providing an audible warning of the movement of the roof supports 16 and the stage loader 60 is not possible, however, due to the noise generated by the equipment during its normal operation. Therefore, the lights 18 on the stage loader 60 can be used, as described above, to advise personnel in the mining environment of imminent movement of the roof supports 16 and the stage loader 60 and to indicate when motion of the equipment has completed, which is not always obvious just by observing the equipment. For example, in some embodiments, one or more of the lights 18 installed on the stage loader 60 can be changed to red to signal movement of the loader 60 and/or the roof supports 16. Also, in some embodiments, lights 18 installed on the stage loader 60 can be controlled in a particular sequence (e.g., color sequence) that is coordinated with the movement of mining equipment as part of a cutting sequence.

Thus, embodiments of the invention relate to controlling lights, such as LEDs, in a mining environment to convey information to personnel located in the mine. In particular, features of the lights, such as color, brightness, status, pattern, position, etc., can be controlled to convey different messages or information to personnel. The lights can also be used to provide area lighting. Therefore, the lights can be operated in at least two different operating modes.

Various features and advantages of the invention are set forth in the following claims.

What is claimed is:

1. A system for controlling lighting in a mining environment, the system comprising:
at least one light emitting diode; and
a controller configured to communicate with the at least one light emitting diode and change the light emitting diode from a first operating mode to a second operating mode, wherein in the first operating mode the at least one light emitting diode provides area lighting and in the second operating mode the at least one light emitting diode conveys information to personnel located in the mining environment, wherein the controller changes the light emitting diode from the first operating mode to the second operating mode based on status information received from at least one device included in the mining environment.

2. The system of claim 1, wherein the at least one light emitting diode is positioned on an upper-side of a roof support.

3. The system of claim 1, wherein the at least one light emitting diode is positioned on a stage loader.

4. The system of claim 1, wherein the at least one light emitting diode includes a multi-color light emitting diode.

5. The system of claim 1, wherein, in the first operating mode, the at least one light emitting diode providing substantially steady, white light.

6. The system of claim 1, wherein, in the second operating mode, the at least one light emitting diode provides flashing light.

7. The system of claim 1, wherein, in the second operating mode, the at least one light emitting diode provides colored light.

8. The system of claim 1, wherein the status information includes information indicating an operating status of a mining machine.

9. The system of claim 1, wherein the status information includes information indicating movement of at least one of a mining machine, a roof support, and a stage loader.

10. The system of claim 1, wherein the status information includes a command to operate the at least one light emitting diode in the second operating mode accordingly to a set of control parameters.

11. The system of claim 1, wherein the controller is configured to determine a set of control parameters based on the received status information.

12. The system of claim 11, wherein the set of control parameters includes at least of a color, a flashing sequence, and a position of the at least one light emitting diode.

13. The system of claim 11, wherein the set of control parameters includes a predetermined time for operating the at least one light emitting diode in the second operating mode.

14. The system of claim 1, wherein the controller is configured to return the at least one light emitting diode to the first operating mode after a predetermined time.

15. The system of claim 1, wherein the controller is configured to return the at least one light emitting diode to the first operating mode based on the received status information.

16. A method for controlling lighting in a mining environment, the method comprising:
operating, by at least one controller, a plurality of light emitting diodes located in the mining environment on at least one of a roof support and a stage loader;
receiving, at the at least one controller, information associated with the mining environment;
operating, by the at least one controller, at least one of the plurality of light emitting diodes to convey information to personnel located in the mining environment based on the received information, wherein operating the at least one of the plurality of light emitting diodes to convey information includes changing at least one of the color, brightness, and flashing sequence of the at least one of the plurality of light emitting diodes.

17. The method of claim 16, wherein receiving the information associated with the mining environment includes receiving information indicating an operating status of a mining machine.

18. The method of claim 16, wherein receiving the information associated with the mining environment includes receiving information indicating movement of at least one of a mining machine, a roof support, and a stage loader.

19. The method of claim 16, further comprising selecting the at least one of the plurality of light emitting diodes based on the status information and a position of each of the plurality of light emitting diodes.

20. The method of claim 16, further comprising stopping operating the at least one of the plurality of light emitting diodes to convey information after a predetermined period of time.

21. The method of claim 16, further comprising stopping operating the at least one of the plurality of light emitting diodes to convey information based on the status information.
